(19) United States
(12) Patent Application Publication
(10) Pub. No.: US 2011/0280542 A1
(43) Pub. Date: Nov. 17, 2011

(54) SECONDARY STORAGE DEVICE

(75) Inventors: Tsukasa ITO, Nagoya-shi (JP); Satoshi SAKAGUCHI, Nagoya-shi (JP)

(73) Assignee: BUFFALO INC., Nagoya-shi (JP)

(21) Appl. No.: 12/969,505

(22) Filed: Dec. 15, 2010

(30) Foreign Application Priority Data
May 13, 2010 (JP) 2010-110852

(51) Int. Cl. H04N 5/775

(52) U.S. Cl. 386/230; 386/E05.07

(57) ABSTRACT

A secondary storage device 100 is used in connection with an electronic device and is configured to include a storage unit having a storage area 132 and a display unit. The secondary storage device 100 identifies a format of the storage area and obtains free space data, which represents a free space of the storage area, from a specified portion in the storage area corresponding to the identified format. The secondary storage device 100 then displays a representation of the free space of the storage area on the display, based on the obtained free space data.

### CROSS-REFERENCE TO RELATED APPLICATION

The present application claims the priority based on Japanese Patent Application No. 2010-110852 filed on May 13, 2010, the disclosure of which is hereby incorporated by reference in its entirety.

### BACKGROUND

1. Technical Field

The present invention relates to a secondary storage device used in connection with an electronic device.

2. Related Art

Recently secondary storage devices have been used in connection with computers, as well as diversity of other electronic devices, for example, a television set having a recording function, an optical disk recorder, and a game machine. These electronic devices generally adopt diversity of data management systems (formats). The secondary storage device is thus initialized (formatted) according to the data management system of a connected electronic device.

Various techniques adopted for such a secondary storage device to display a free space of a storage area by means of an LED or on a liquid crystal display have been disclosed in, for example, Patent Literatures 1 to 5 given below. Any of the techniques described in these literatures, however, does not take into account the data management system of a connected electronic device. There is accordingly a possibility that the secondary storage device fails to display an accurate representation of the free space according to the type of an electronic device connected with the secondary storage device.
[Patent Literature 1] JP-A-2007-242225
[Patent Literature 2] JP-A-2004-13922
[Patent Literature 3] JP-A-1990-240890
[Patent Literature 4] JP-A-1990-254693
[Patent Literature 5] JP-A-1989-51546

### SUMMARY

By taking into account the issue discussed above, a first object of the invention is to provide a secondary storage device configured to display an adequate representation of a free space according to the data management system of a connected electronic device. A second object of the invention is to provide a secondary storage device configured to display useful information, in addition to the free space.

In order to attain at least part of the objects described above, one aspect of the invention is directed to a secondary storage device connected with an electronic device. The secondary storage device comprises a storage unit having a storage area; a format identifier adapted to identify a format of the storage area; a free space data acquiring unit adapted to acquire free space data representing a free space of the storage area, from a specified portion in the storage area corresponding to the identified format; and a display unit adapted to display a representation of the free space of the storage area, based on the acquired free space data.

The secondary storage device according to this aspect acquires the free space data, which represents the free space of the storage area, from the specified portion in the storage area corresponding to the format of the storage area. The secondary storage device of this arrangement enables an adequate representation of the free space to be displayed according to the data management system of the connected electronic device.

In a preferable aspect, the secondary storage device further comprises a reserved space data acquiring unit adapted to acquire reserved space data representing an expected data volume to be written into the storage area from the electronic device, wherein the display unit displays a representation of the expected data volume to be written into the storage area, based on the acquired reserved space data.

The secondary storage device of this aspect enables the user to easily recognize a free space that will be occupied in the near future.

In a preferable aspect, the display unit displays a representation of a residual space computed by subtracting the expected data volume represented by the reserved space data from the free space.

The secondary storage device of this aspect enables a representation of an expected free space with reflection of a free space that will be occupied in the near future to be displayed as the temporary free space.

In a preferable aspect, the secondary storage device further comprises a character information acquiring unit adapted to acquire character information related to data stored in the storage area or data expected to be written into the storage area, from the electronic device, wherein the display unit displays the acquired character information.

The secondary storage device of this aspect enables display of the character information in relation to the data stored in the storage area or the data expected to be written into the storage area, in addition to the free space. This arrangement provides the user with useful information.

In a preferable aspect, wherein the electronic device includes a tuner for receiving a broadcasted program, and the character information acquiring unit acquires information including a name of the broadcasted program as the character information.

In this aspect, the name of the broadcasted program can be displayed on the secondary storage device. Even when the name of a broadcasted program is not shown on the electronic device, this aspect enables the user to easily recognize the name of the broadcasted program. The broadcasted program may be a television program or a radio program.

In a preferable aspect, the free space data acquiring unit acquires the free space data, when the electronic device writes data into the storage area.

The secondary storage device of this aspect obtains the free space data, when data is written into the storage area. This aspect enables a variation in free space of the storage area to be momentarily displayed.

The present invention is not restricted to the secondary storage device having any of the above aspects but may be actualized by, for example, a control method of such a secondary storage device and a computer program configured to control such a secondary storage device. The computer program may be recorded in a computer readable recording medium. Any of various media, such as a flexible disk, a CD-ROM, a DVD-ROM, a magneto optical disk, a memory card, or a hard disk, may be used as this recording medium.

These and other objects, features, aspects, and advantages of the invention will become more apparent from the following detailed description of the preferred embodiments with the accompanying drawings.

### BRIEF DESCRIPTION OF THE DRAWINGS

FIG. 1 is an explanatory diagrammatic representation of the general configuration of a secondary storage device and a host device;

FIG. 2 is a diagrammatic representation of the data structure of an SCSI command;

FIG. 3 is a flowchart of an initial display routine;

FIG. 4 is an explanatory diagrammatic representation of one exemplary display of a free space on a liquid crystal display unit;

FIG. 5 is a flowchart of a main display routine;

FIG. 6 is an explanatory diagrammatic representation of one exemplary display of a temporary free space and the name of a broadcasted program set for programmed recording; and

FIG. 7 is an explanatory diagrammatic representation of one exemplary display of the name of a program currently played back.

### DESCRIPTION OF THE PREFERRED EMBODIMENTS

A. Device Configuration

One mode of carrying out the invention is described below as an embodiment with reference to the accompanied drawings.

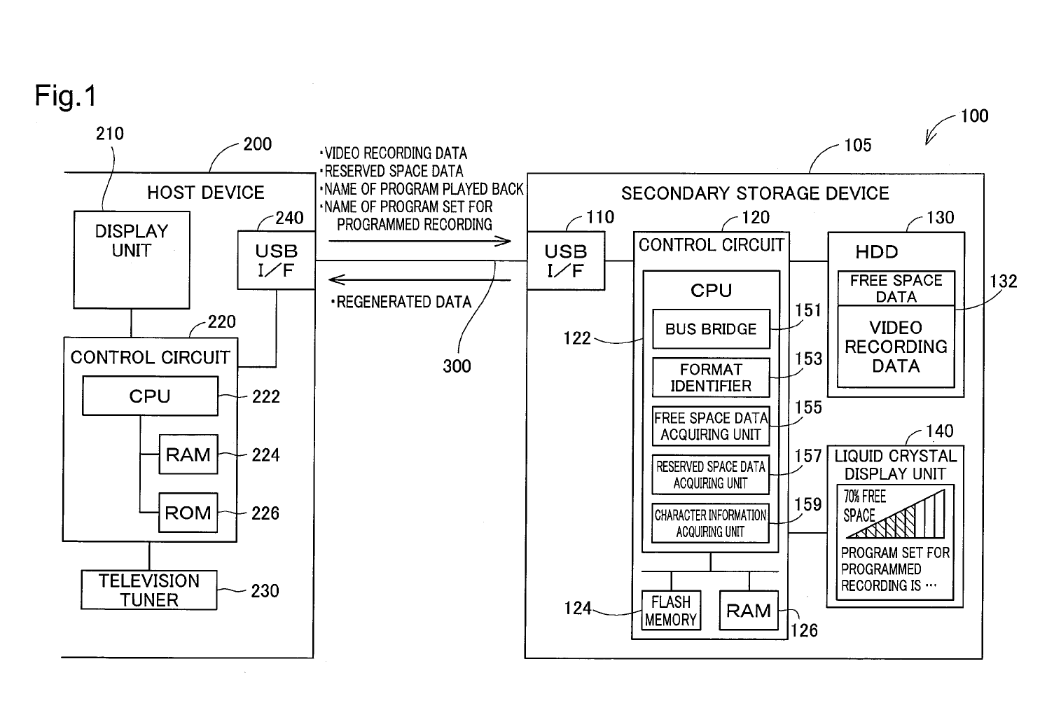

FIG. 1 is an explanatory diagrammatic representation of the general configuration of a secondary storage device 100 and a host device 200 as one embodiment according to the invention. In this embodiment, the host device 200 is a television receiver designed to enable storage of video recording data into the secondary storage device 100. The host device 200 includes a display unit 210 of, for example, a liquid crystal type or a plasma type, a control circuit 220 having a CPU 222, a RAM 224, and a ROM 226, a television tuner 230, and a USB (Universal Serial Bus) interface 240. The control circuit 220 has a function of sending video data of a television program received by the television tuner 230 in the form of video recording data to the secondary storage device 100 via the USB interface 240.

The secondary storage device 100 includes a casing 105, a USB interface 110, a control circuit 120, a hard disk drive 130, and a liquid crystal display unit 140. In this embodiment, the hard disk drive 130 is connected with the control circuit 120 via a SATA (Serial ATA) interface and is operated in an AHCI (Advanced Host Controller Interface) mode. The hard disk drive 130 is, however, not restrictively connected via the SATA interface but may be connected with the control circuit 120 via a PATA (Parallel ATA) interface and may be operated in any other adequate mode (for example, an IDE mode).

The host device 200 is connected with the USB interface 110 via a USB cable 300. The USB interface 110 receives an USB electric signal from the host device 200 through the USB cable 300 and transmits the received electric signal in the form of a digital data signal to the control circuit 120. The control circuit 120 has a CPU 122, a flash memory 124, and a RAM 126. The CPU 122 loads and executes firmware prestored in the flash memory 124 onto the RAM 126, so as to serve as a bus bridge 151, a format identifier 153, a free space data acquiring unit 155, a reserved space data acquiring unit 157, and a character information acquiring unit 159.

The bus bridge 151 has a function of mutually converting communication protocols between the host device 200 and the hard disk drive 130. More specifically, the bus bridge 151 analyzes a USB packet received from the host device 200 via the USB interface 110 and extracts an SCSI command and data (for example, video recording data) from the analyzed USB packet. The extracted command and data are transferred to the hard disk drive 130. The bus bridge 151 also receives an SCSI reply command and data from the hard disk drive 130, packs the received reply command and data into a USB packet, and transfers the USB packet to the host device 200 via the USB interface 110.

The format identifier 153 has a function of identifying the type of format (data management system) of a storage area 132 in the hard disk drive 130 connected with the control circuit 120. Identification data for uniquely identifying the type of format is stored in the storage area 132. The format identifier 153 reads the stored identification data to identify the type of format. The identification data may be recorded at different addresses corresponding to different types of formats. The format identifier 153 accordingly has storage of addresses of the identification data in correlation to the respective formats, and sequentially accesses these addresses to identify the type of format. In this embodiment, the format identifier 153 explicitly identifies three different formats “FAT32”, “HFS”, and “XFS”, while recognizing any other formats as “unknown formats”. The format identifier 153 may be designed to identify any format other than these three formats. As long as the type of format is identifiable, data at a fixed position in the storage area 132 (for example, data of a first preset number of bits in a first sector) may be used as the identification data to identify the format.

The free space data acquiring unit 155 has a function of acquiring free space data, which represents a free space of the storage area 132, from a specified portion in the storage area 132. The free space data is recorded at different positions corresponding to the types of formats. The free space data acquiring unit 155 accordingly accesses a position (address, sector, or block) corresponding to the format identified by the format identifier 153 to acquire the free space data. For example, in the format FAT 32, the free space data is recorded in a portion called “FS Information Sector” in the storage area 132. In the format HFS, the free space data is recorded in a portion called “Volume Header” starting at a 1024-th byte from the head of the storage area 132. In the format XFS, the free space data is recorded in a portion called “AG Free Space Block” in a second sector of the storage area 132. In this embodiment, in addition to the free space data, the free space data acquiring unit 155 acquires total capacity data, which represents a total capacity of the storage area 132, from a specified portion in the storage area 132. The total capacity data may be recorded in a different portion from the portion where the free space data is recorded. The free space data acquiring unit 155 accordingly acquires the total capacity data from a position corresponding to the format identified by the format identifier 153. For example, in the format FA32, the total capacity data is recorded in a portion called “Bios Parameter Block” in the storage area 132. In the format HFS, the total capacity data is recorded in the same portion “Volume Header” where the free space data is recorded. In the format XFS, the total capacity data is recorded in a portion called “Super Blocks”.

The reserved space data acquiring unit 157 has a function of acquiring data (reserved space data), which represents a storage capacity required for programmed recording of a broadcasted program set by the host device 200, from the host device 200 and displaying the acquired reserved space data on the liquid crystal display unit 140. The reserved space data is computed from a recording time and an average bit rate by the host device 200. The average bit rate is, for example, about 17 Mbps for digital terrestrial broadcasting and about 24 Mbps for BS digital broadcasting in Japan.

The character information acquiring unit 159 has a function of acquiring diversity of character information from the host device 200 and displaying the acquired character information on the liquid crystal display unit 140. The acquired character information includes, for example, the name of a broadcasted program currently played back, the name of a broadcasted program currently received, or the name of a broadcasted program set for programmed recording by the host device 200.

The reserved space data acquiring unit 157 and the character information acquiring unit 159 analyze an SCSI command, which is sent from the host device 200 to the hard disk drive 130 via the bus bridge 151, in order to acquire the reserved space data and the character information, respectively. The reserved space data and the character information are embedded as vender-specific information in the SCSI command.

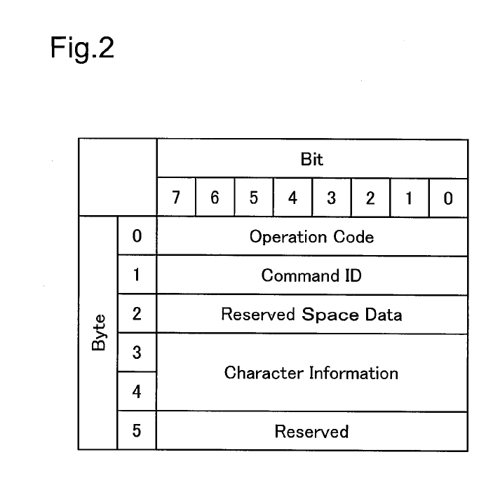

FIG. 2 is a diagrammatic representation of the data structure of the SCSI command. As shown in FIG. 2, the SCSI command is constructed as 6-byte data. A first byte represents an operation code (representing a command type, such as “read” or “write”). A second byte represents a command ID specified to each operation code. In the SCSI command of this embodiment, a unique operation code specific to the secondary storage device 100 is written at the first byte, and the reserved space data and the character information are written at third and subsequent bytes. This data structure enables transmission of the reserved space data and the character information from the host device 200 to the second storage device 100. As shown in FIG. 2, a 2-byte space is set for describing the character information. When the character information requires a storage capacity of more than 2 bytes, multiple SCSI commands are to be sent sequentially. In the following description, an SCSI command for sending the reserved space data and the name of a broadcasted program set for programmed recording as the character information is referred to as “record programming command”. An SCSI command for sending the name of a broadcasted program currently played back as the character information is referred to as “program name display command”.

B. Initial Display Routine

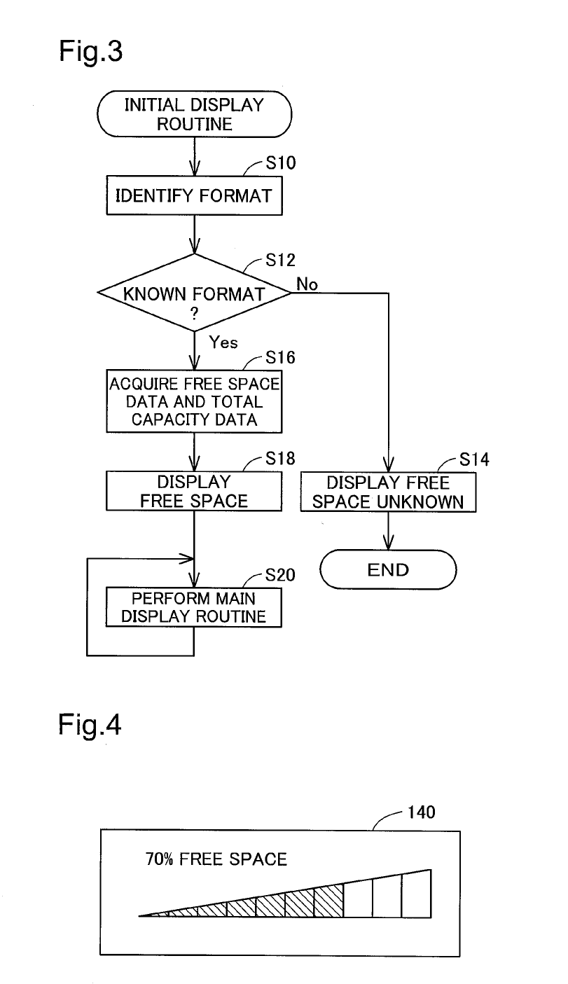

FIG. 3 is a flowchart of an initial display routine performed by the CPU 122 of the secondary storage device 100. Power-on of the secondary storage device 100 triggers this initial display routine to display the free space of the storage area 132 on the liquid crystal display unit 140.

In this initial display routine, the CPU 122 or more specifically the format identifier 153 identifies the format of the storage area 132 (step S10) and determines whether the identified format is any of the known formats, FAT32, HFS, and XFS (step S12). When the identified format is an unknown format, the CPU 122 displays a representation that the free space is unknown, on the liquid crystal display unit 140 (step S14). More detailed information, for example, “The format is out of support, so that the free space is unknown”, may be displayed here. After the display of the representation that the free space is unknown, the CPU 122 terminates this initial display routine.

On determination at step S12 that the identified format is any of the known formats (FAT32, HFS, and XFS), the CPU 122 or more specifically the free space data acquiring unit 155 acquires the free space data and the total capacity data from the specified portions in the storage area 132 corresponding to the identified format (step S16). After acquisition of the free space data and the total capacity data, the free space data acquiring unit 155 displays the free space of the storage area 132 on the liquid crystal display unit 140, based on these acquired data.

FIG. 4 is an explanatory diagrammatic representation of one exemplary display of the free space on the liquid crystal display unit 140. As shown in FIG. 4, in this embodiment, a percentage of the free space to the total capacity of the storage area 132 is shown by both a numerical representation and a graphical meter. The display of the free space is not restricted to this example. For example, a numerical value representing the actual amount of free space may be displayed directly. In another example, the percentage of the free space and the actual amount of free space may be displayed simultaneously. After the display of the free space in such a manner, the CPU 122 terminates the initial display routine and shifts the processing flow to a main display routine (step S20).

C. Main Display Routine

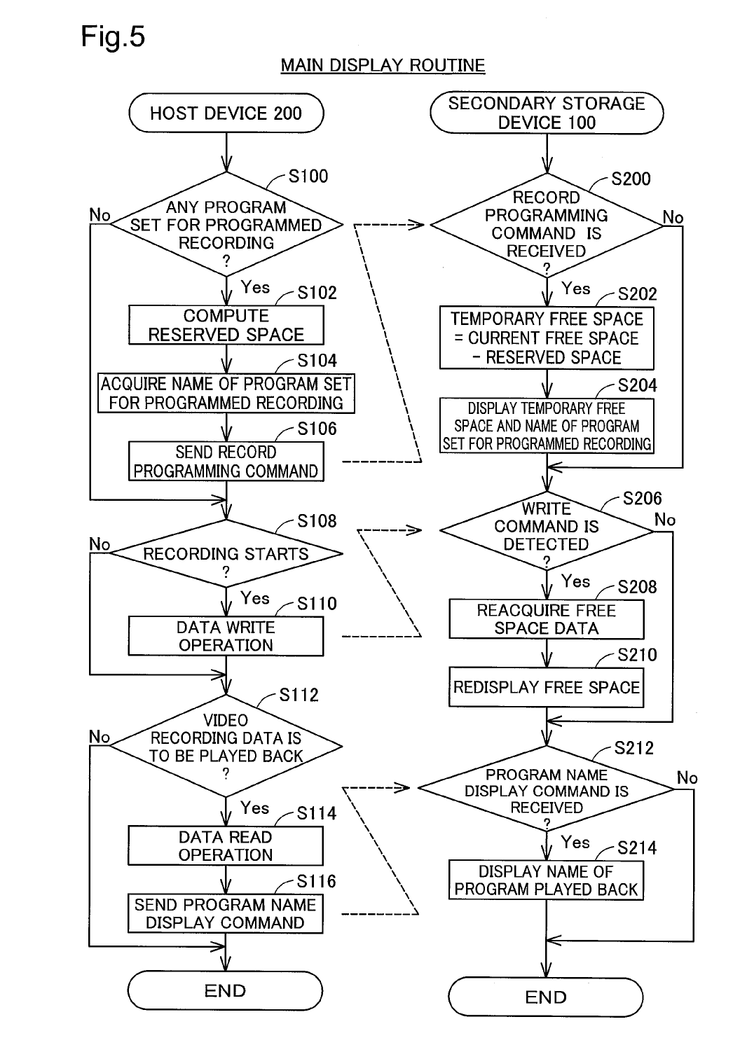

FIG. 5 is a flowchart of the main display routine performed subsequent to the initial display routine. The main display routine of FIG. 5 includes both a processing flow performed by the host device 200 and a processing flow performed by the secondary storage device 100. The flowchart of FIG. 5 shows only an extracted series of processing performed to display various pieces of information on the liquid crystal display unit 140 by the secondary storage device 100 and does not show all series of processing performed by the host device 200 and the secondary storage device 100. In the main display routine of FIG. 5, the CPU 222 of the host device 200 determines whether any broadcasted program has been set for programmed recording on, for example, electronic program guides (step S100). On determination that any broadcasted program has been set for programmed recording, the CPU 222 computes a reserved space from a broadcasting time of the broadcasted program set for programmed recording and an average bit rate and generate reserved space data representing the computed reserved space (step S102). The CPU 222 subsequently acquires the name of the broadcasted program set for programmed recording from, for example, the electronic program guides (step S104). The CPU 222 then generates a record programming command including the generated reserved space data and the acquired name of the broadcasted program set for programmed recording and sends the generated record programming command to the secondary storage device (step S106).

The CPU 122 of the secondary storage device 100 receives the record programming command from the host device 200 (step S200). The CPU 122 or more specifically the reserved space data acquiring unit 157 then acquires the reserved space data from the received record programming command and subtracts the reserved space represented by the acquired reserved space data from the current free space to compute a temporary free space (step S202). The reserved space data acquiring unit 157 displays the computed temporary free space as an expected free space after completion of the programmed recording, as well as the name of the broadcasted program set for programmed recording acquired from the record programming command onto the liquid crystal display unit 140 (step S204).

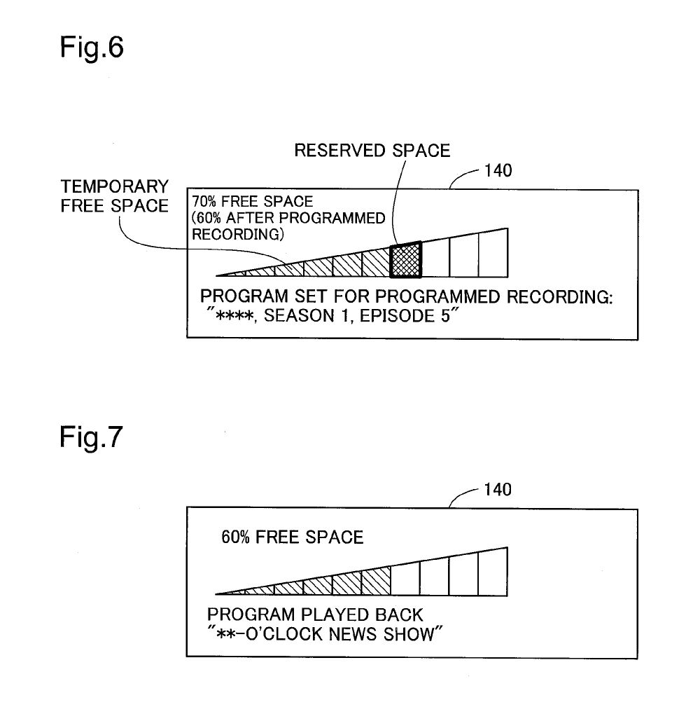

FIG. 6 is an explanatory diagrammatic representation of one exemplary display of the temporary free space and the name of the broadcasted program set for programmed recording on the liquid crystal display unit 140. In this embodiment, the reserved space is displayed simultaneously with the temporary free space. The simultaneous display of the temporary free space and the reserved space enables the user to easily recognize a storage capacity required for programmed recording and a remaining storage capacity after the programmed recording. On completion of the programmed recording, the CPU 122 deletes the display of the reserved space corresponding to the programmed recording. The CPU 122 may detect completion of the programmed recording, for example, by receiving a command representing completion of the programmed recording from the host device 200.

Referring back to FIG. 5, the CPU 222 of the host device 200 detects a start of recording (including programmed recording and manual recording) (step S108) and performs a data write operation of writing video recording data into the secondary storage device 100 (step S110). In the data write operation, the host device 200 sends a write command in the form of an SCSI command to the secondary storage device 100 to write data into the secondary storage device 100. The host device 200 updates the free space data recorded in the storage area 132, accompanied with this data write operation.

The CPU 122 of the secondary storage device 100 or more specifically the bus bridge 151 detects transmission of the write command from the host device 200 (step S206). The CPU 122 or more specifically the free space data acquiring unit 155 then reacquires the free space data from the storage area 132 (step S208) and redisplays the free space on the liquid crystal display unit 140, based on the reacquired free space data (step S210). The free space data may be reacquired, for example, at preset time intervals, for example, at every 10 seconds. In this embodiment, the free space is redisplayed, in response to transmission of the write command from the host device 200. This arrangement enables the user to momentarily check a variation in free space.

The CPU 222 of the host device 200 subsequently determines whether an instruction is given to play back video recording data (step S112). On determination that the instruction is given to play back video recording data, the CPU 222 performs a data read operation of reading the video recording data from the hard disk drive 130 of the secondary storage device 100 (step S114). The CPU 222 acquires the name of a broadcasted program included in the read video recording data and sends a program name display command describing the acquired name of the broadcasted program (step S116).

The CPU 122 of the secondary storage device 100 receives the program name display command from the host device 200 (step S212) and displays the name of the broadcasted program included in the received program name display command on the liquid crystal display unit 140 (step S214). FIG. 7 shows one exemplary display of the name of the broadcasted program currently played back. The main display routine described above is performed repeatedly until the secondary storage device 100 is powered off.

In the secondary storage device 100 of this embodiment described above, the free space of the storage area 132 is displayed on the liquid crystal display unit 140 of the secondary storage device 100. Such display enables the user to easily recognize the usage of the secondary storage device 100. In this embodiment, the secondary storage device 100 detects the free space of the storage area 132 through the series of processing by its own CPU 122 without any instruction from the host device 200. The secondary storage device 100 of the embodiment thus enables display of the free space even in a power-off state of the host device 200. The secondary storage device 100 of this embodiment acquires the free space data from the specified portion in the storage area 132 corresponding to the format of the storage area 132. This assures adequate display of the free space according to the data management system of the connected host device 200.

The secondary storage device 100 of the embodiment receives various commands from the host device 200 to display diverse pieces of useful information, for example, the name of a broadcasted program set for programmed recording or the name of a broadcasted program currently played back, as well as the free space of the storage area 132. The display on the liquid crystal display unit 140 of the secondary storage device 100 enables the user to easily recognize, for example, the name of a broadcasted program currently played back, which is conventionally recognizable only by the user's press of a predetermined button on the host device 200.

D. Modifications

One embodiment of the present invention is described above. The embodiment discussed above is to be considered in all aspects as illustrative and not restrictive. There may be many modifications, changes, and alterations without departing from the scope or spirit of the main characteristics of the present invention. For example, the functions of the software configuration may be actualized by the hardware configuration. Some other examples of possible modification are given below.

In the embodiment discussed above, on detection of any unknown format, the initial display routine performed in the secondary storage device 100 displays the representation that the free space is unknown. In one modification, on detection of any unknown format, the host device 200 may compute a free space in the hard disk drive 130 and transfer the computed free space to the secondary storage device 100. The secondary storage device 100 can accordingly display free spaces corresponding to all available formats, as long as the free spaces of these formats are computable by the host device 200.

In the embodiment discussed above, the main display routine is not performed when the identified format is an unknown format in the initial display routine. In one modification, even when the identified format is an unknown format, the main display routine may be performed to display any available piece of information other than the free space, for example, the name of a broadcasted program set for programmed recording or the name of a broadcasted program currently played back.

In the configuration of the above embodiment, the secondary storage device 100 is equipped with the hard disk drive 130. The hard disk drive 130 may be replaced with a flash memory medium, such as an SSD (Solid State Drive), or a recordable optical disk medium. The secondary storage device 100 may be designed to enable the user' free replacement or exchange of a desired storage unit, for example, the hard disk drive 130 or the SSD. Namely the present invention may be configured as an enclosure case to which a storage unit is attachable or as a connection adapter configured to mediate connection between a storage unit and the host device 200.

In the configuration of the above embodiment, the secondary storage device 100 is connected with the host device 200 via the USB interface. The interface adopted for such connection is, however, not restricted to the USB interface but may be any of other diverse interfaces, for example, an IEEE1394 interface, an eSATA interface, a fiber channel interface, or an Ethernet (registered trademark) interface. The protocol transmitted between the host device 200 and the hard disk drive 130 is not restricted to SCSI but may be any of other diverse protocols, for example, IDE, ATA, ATAPI, or SATA.

In the configuration of the above embodiment, the host device 200 is equipped with the liquid crystal display unit 140. The host device 200 may include a display unit of any other suitable system, for example, an organic EL display, an LED, or a fluorescent indicator tube. Plural different display units may be used in combination for the display. For example, the free space of the storage area 132 may be displayed by an LED, while the character information may be displayed on the liquid crystal display unit 140.

The secondary storage device 100 of the embodiment is configured to display the free space, the name of a broadcasted program set for programmed recording, the name of a broadcasted program currently played back on the liquid crystal display unit 140. The display of all such pieces of information is, however, neither essential nor restrictive. Only one piece of information or a combination of two or more pieces of information may be displayed instead. In addition to or in place of these pieces of information, any other suitable pieces of information may be acquired from the host device 200 to be displayed; for example, the name of a broadcasted program currently received, as well as the detailed information, the cast, the data format, or the captions or subtitles of a broadcasted program.

In the configuration of the above embodiment, the secondary storage device 100 is provided outside the host device 200. The secondary storage device 100 may alternatively be built in the host device 200. The liquid crystal display unit 140 of the secondary storage device 100 may be provided separately in a different casing from the secondary storage device 100.

In the embodiment discussed above, the host device 200 is a television receiver. The host device 200 is, however, not restricted to the television receiver but may be any of other diverse electronic devices, for example, a personal computer, an optical disk recorder, a game machine, or a radio receiver. The secondary storage device 100 may accordingly be configured to store any of diverse data according to the type of the host device 200, for example, sound data, game data, or document data, as well as video data. Information displayed may be determined according to the type of the data stored; for example, the name of a music piece, the name of an artist, the name of a game, or the name of a file.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A secondary storage device connected with an electronic device, comprising:
a storage unit having a storage area;
a format identifier adapted to identify a format of the storage area;
a free space data acquiring unit adapted to acquire free space data representing a free space of the storage area, from a specified portion in the storage area corresponding to the identified format; and
a display unit adapted to display a representation of the free space of the storage area, based on the acquired free space data.

2. The secondary storage device according to claim 1, further comprising:
a reserved space data acquiring unit adapted to acquire reserved space data representing an expected data volume to be written into the storage area from the electronic device,
wherein the display unit displays a representation of the expected data volume to be written into the storage area, based on the acquired reserved space data.

3. The secondary storage device according to claim 2, wherein the display unit displays a representation of a residual space computed by subtracting the expected data volume represented by the reserved space data from the free space.

4. The secondary storage device according to claim 1, further comprising:
a character information acquiring unit adapted to acquire character information related to data stored in the storage area or data expected to be written into the storage area, from the electronic device,
wherein the display unit displays the acquired character information.

5. The secondary storage device according to claim 4, wherein the electronic device includes a tuner for receiving a broadcasted program, and
the character information acquiring unit acquires information including a name of the broadcasted program as the character information.

6. The secondary storage device according to claim 1, wherein the free space data acquiring unit acquires the free space data, when the electronic device writes data into the storage area.

7. A control method of a secondary storage device including a storage unit and a display unit, comprising:
identifying a format of a storage area included in the storage unit;
acquiring free space data representing a free space of the storage area, from a specified address in the storage area corresponding to the identified format; and
displaying a representation of the free space of the storage area on the display unit, based on the acquired free space data.
